(19) United States
(12) Patent Application Publication
(10) Pub. No.: US 2012/0081226 A1
(43) Pub. Date: Apr. 5, 2012

(54) BURGLARPROOF SECURITY SYSTEM AND INSTALLING METHOD THEREOF

(75) Inventor: Chin-Wang Hu, Jhubei City (TW)

(73) Assignee: YUN XIANG TECHNOLOGY INC., Jhubei City (TW)

(21) Appl. No.: 12/898,234

(22) Filed: Oct. 5, 2010

(51) Int. Cl. G08B 13/00; H01R 43/00

(52) U.S. Cl. 340/541; 29/825

(57) ABSTRACT

A burglarproof security system includes a substrate, a conducting wire layer, a sensing control unit, an alarm device and a power supply. The conducting wire layer is disposed on the substrate, and includes plural conducting wires. The plural conducting wires collectively define either a resistive sensing circuit or a capacitive sensing circuit. The sensing control unit is electrically connected with the plural conducting wires of the conducting wire layer for controlling and selectively switching the plural conducting wires to define either the resistive sensing circuit or the capacitive sensing circuit, and detecting the resistive sensing circuit or the capacitive sensing circuit, thereby generating a detecting signal. When the detecting signal from the sensing control unit is received by the alarm device, the alarm device generates a warning signal. The power supply is electrically connected with the sensing control unit and the alarm device for providing electric power.

### FIELD OF THE INVENTION

The present invention relates to a burglarproof security system, and more particularly to a burglarproof security system applied to a substrate (e.g. a glass plate, an acrylic plate or a ceramic plate). The present invention also relates to a method of installing the burglarproof security system.

### BACKGROUND OF THE INVENTION

Generally, when burglars believe no one is around a home or a car and the home or the car appears to be easy to get inside, they may break into the home or the car to take valuable possessions. One of the best ways to deter burglars from going into the home or the car is to install a burglarproof security system. The use of the burglarproof security system may reduce the possibility of incurring burglary, breakage, man-made damage or other criminal events. As known, one of the common burglarproof security systems utilizes a vibration sensor to judge whether a glass plate is broken by a foreign article.

FIG. 1 is a schematic diagram illustrating a conventional burglarproof security system. In the burglarproof security system, a vibration sensor 11 is attached on a corner of a glass plate 10. The vibration sensor 11 is electrically connected to an alarm device 12 through a transmission line 13. In a case that the glass plate 10 is damaged by an external force or suffered from a shock, vibration is generated. Once the vibration is detected by vibration sensor 11, a sensing signal is transmitted to the alarm device 12 through the transmission line 13. In response to the sensing signal, the alarm device 12 issues a warning signal to notify the guard or the security service personnel. Consequently, the burglarproof security efficacy will be achieved.

The conventional burglarproof security system, however, still has some drawbacks. For example, the use of the vibration sensor 11 has a high false-alarm rate. A strong wind, an earthquake, a passage of a large-sized vehicle, erroneous touch of a person or a push of the glass plate 10 may result in vibration. In response to the vibration, the vibration sensor 11 may issue the sensing signal to the alarm device 12 and notify the guard or the security service personnel. The guard or the security service personnel is usually perplexed at the high false-alarm rate. On the other hand, if the sensitivity of the vibration sensor 11 is reduced, a breakage at a non-corner position may fail to be sensed by the vibration sensor 11. In this situation, the burglarproof security efficacy is largely impaired.

For obviating the drawbacks encountered from the prior art, there is a need of providing a burglarproof security system applied to a substrate (e.g. a glass plate, an acrylic plate or ceramic plate) and a method of installing the burglarproof security system.

### SUMMARY OF THE INVENTION

The present invention provides a burglarproof security system applied to a substrate (e.g. a glass plate, an acrylic plate or a ceramic plate) in order to accurately prompt the warning information and meet the cost-effective requirement.

The present invention also provides a burglarproof security system for detecting whether a substrate has a fracture or crack or is touched by a foreign article at a reduced false-alarm rate.

The present invention further provides a burglarproof security system operable in different detecting modes according to the practical requirements, so that the detecting sensitivity and accuracy are both taken into consideration.

The present invention further provides a method of installing a burglarproof security system, in which a conducting wire layer is formed on a substrate by a burying, spraying or adhering means. The burglarproof security system is selectively formed during the process of producing the substrate in order to reduce resource waste and meet the cost-effective requirement.

In accordance with an aspect of the present invention, there is provided a burglarproof security system. The burglarproof security system includes a substrate, a conducting wire layer, a sensing control unit, an alarm device and a power supply. The conducting wire layer is disposed on the substrate, and includes plural conducting wires. The plural conducting wires collectively define either a resistive sensing circuit or a capacitive sensing circuit. The sensing control unit is electrically connected with the plural conducting wires of the conducting wire layer for controlling and selectively switching the plural conducting wires to define either the resistive sensing circuit or the capacitive sensing circuit, and detecting the resistive sensing circuit or the capacitive sensing circuit, thereby generating a detecting signal. The alarm device is in communication with the sensing control unit for receiving the detecting signal from the sensing control unit, thereby generating a warning signal. The power supply is electrically connected with the sensing control unit and the alarm device for providing electric power.

In accordance with another aspect of the present invention, there is provided a burglarproof security system. The burglarproof security system includes a substrate, a conducting wire layer, a sensing control unit and an alarm device. The conducting wire layer is disposed on the substrate, and includes plural conducting wires. The plural conducting wires collectively define either a resistive sensing circuit or a capacitive sensing circuit. The sensing control unit includes a detecting device, wherein the detecting device is electrically connected with either the resistive sensing circuit or the capacitive sensing circuit for detecting the resistive sensing circuit or the capacitive sensing circuit, thereby generating a detecting signal. The alarm device is in communication with the sensing control unit for receiving the detecting signal from the sensing control unit, thereby generating a warning signal.

In accordance with a further aspect of the present invention, there is provided a method of installing a burglarproof security system. Firstly, a substrate, a conducting wire layer, a sensing control unit, an alarm device and a power supply are provided. The conducting wire layer comprises plural conducting wires, and the plural conducting wires collectively define either a resistive sensing circuit or a capacitive sensing circuit. The power supply is electrically connected with the sensing control unit and the alarm device for providing electric power. Then, the conducting wire layer is formed on the substrate. Then, the sensing control unit is electrically connected with the plural conducting wires of the conducting wire layer and the alarm device.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram illustrating a conventional burglarproof security system;

FIG. 2 is a schematic diagram illustrating a burglarproof security system applied to a substrate according to an embodiment of the present invention;

FIG. 3 is a schematic diagram illustrating a burglarproof security system applied to a substrate according to another embodiment of the present invention;

FIG. 4 is a schematic diagram illustrating the burglarproof security system of the present invention operated in a resistive detecting mode;

FIGS. 5A and 5B are schematic diagrams illustrating the occurrence of a fracture or crack on the substrate of the burglarproof security system as shown in FIG. 4;

FIG. 6 is a schematic diagram illustrating the burglarproof security system of the present invention operated in a capacitive detecting mode;

FIGS. 7A and 7B are schematic diagrams illustrating the capacitance change of the capacitive sensing circuit in response to a touching action of a foreign article on the substrate of the burglarproof security system as shown in FIG. 6;

FIG. 8 is a flowchart illustrating a method of installing a burglarproof security system according to an embodiment of the present invention;

FIGS. 9A˜9D schematically illustrate the steps of forming a conducting wire layer on a substrate by a burying means;

FIGS. 10A˜10D schematically illustrate the steps of forming a conducting wire layer on a substrate by a spraying means;

FIGS. 11A˜11D schematically illustrate the steps of forming a conducting wire layer on a substrate by an adhering means; and

FIGS. 12A and 12B are schematic diagrams illustrating two application examples of a burglarproof security system according to an embodiment of the present invention.

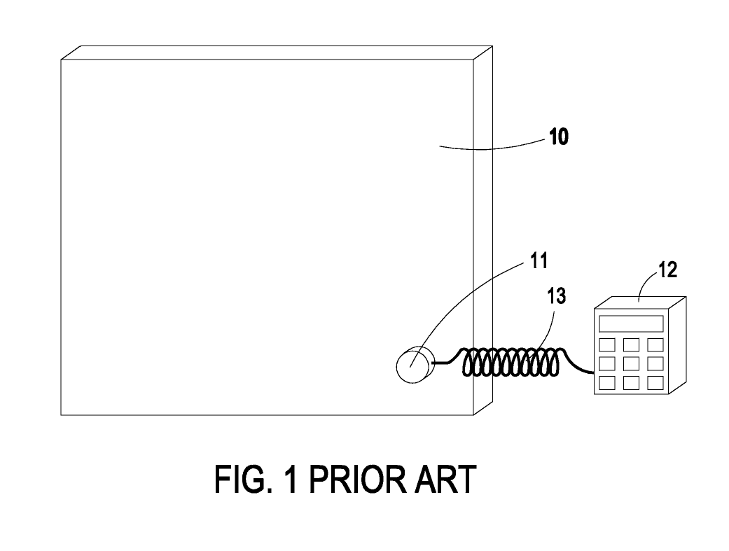

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention provides a burglarproof security system applied to a substrate. The present invention is illustrated by referring a glass plate, an acrylic plate or a ceramic plate as a substrate. Nevertheless, the substrate is not restricted to the glass plate, the acrylic plate and the ceramic plate.

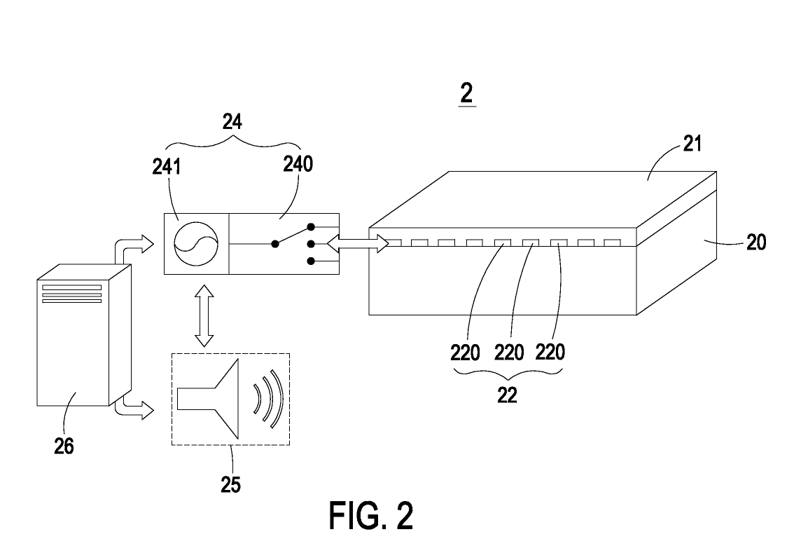

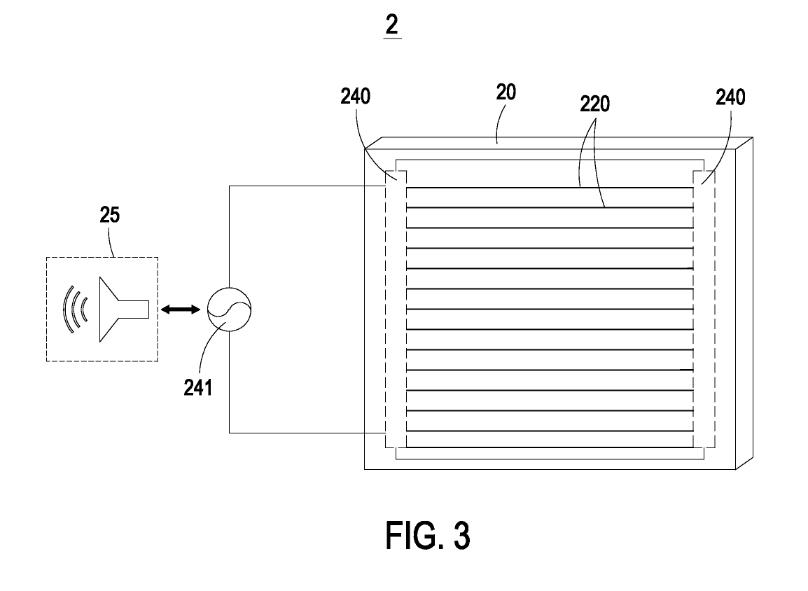

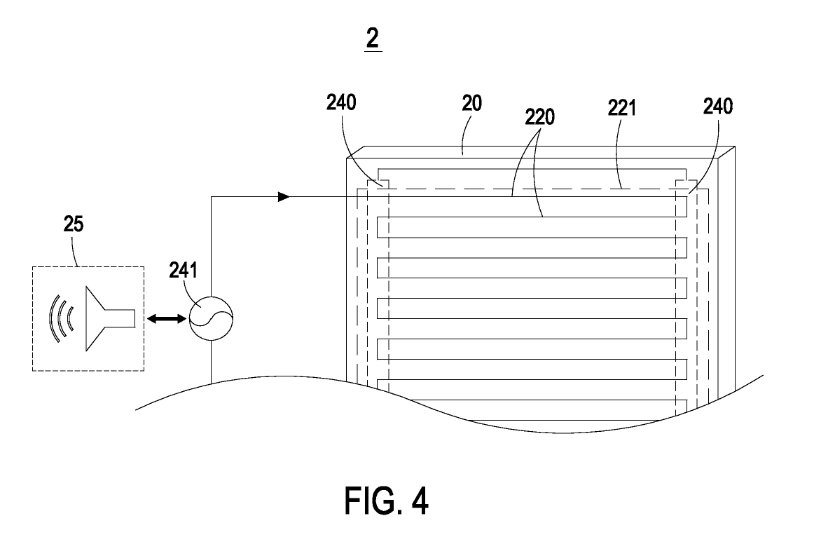

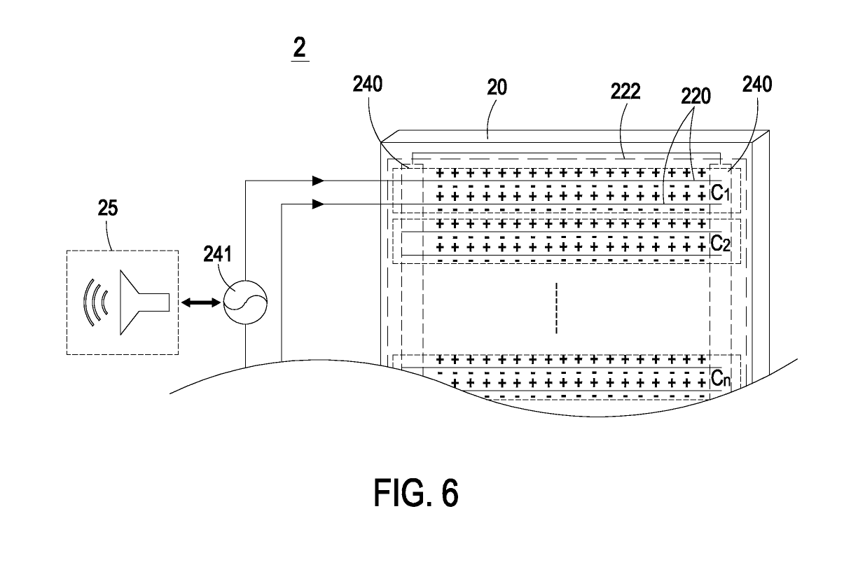

FIG. 2 is a schematic diagram illustrating a burglarproof security system applied to a substrate according to an embodiment of the present invention. FIG. 3 is a schematic diagram illustrating a burglarproof security system applied to a substrate according to another embodiment of the present invention. The burglarproof security system 2 comprises a substrate 20, a conducting wire layer 22, a sensing control unit 24, an alarm device 25 and a power supply 26. The conducting wire layer 22 is disposed on the substrate 20, and comprises plural conducting wires 220. Optionally, the plural conducting wires 220 collectively define either a resistive sensing circuit 221 (see FIG. 4) or a capacitive sensing circuit 222 (see FIG. 6). The sensing control unit 24 is electrically connected with the plural conducting wires 220 of the conducting wire layer 22 for controlling and selectively switching the plural conducting wires 220 to define either the resistive sensing circuit 221 or the capacitive sensing circuit 222. In addition, the sensing control unit 24 is used for detecting either the resistive sensing circuit 221 or the capacitive sensing circuit 222, thereby generating a detecting signal. The alarm device 25 is in communication with the sensing control unit 24 for receiving the detecting signal. In response to the detecting signal, the alarm device 25 generates a warning signal. The power supply 26 is electrically connected with the sensing control unit 24 and the alarm device 25 for providing electric power. Optionally, a protective layer 21 is formed on the conducting wire layer 22 and the substrate 20.

In this embodiment, the sensing control unit 24 comprises a switching device 240 and a detecting device 241. The switching device 240 is electrically connected to the plural conducting wires 220 of the conducting wire layer 22 for controlling and selectively switching the plural conducting wires 220 to be either the resistive sensing circuit 221 or the capacitive sensing circuit 222. The detecting device 241 is electrically connected with either the resistive sensing circuit 221 or the capacitive sensing circuit 222 through the switching device 240. The detecting device 241 is used for detecting either the resistive sensing circuit 221 or the capacitive sensing circuit 222, thereby generating a detecting signal. In a case that the detecting device 241 is electrically connected with the resistive sensing circuit 221, the detecting device 241 may judge whether the resistive sensing circuit 221 is in an open-circuit status because of a fracture or crack of the substrate 20. Whereas, in a case that the detecting device 241 is electrically connected with the capacitive sensing circuit 222, the detecting device 241 may judge whether the capacitance value of the capacitive sensing circuit 222 is changed in response to a touching action of a foreign article. That is, the detecting device 241 will generate the detecting signal when the substrate 20 has a fracture or crack or is touched by a foreign article.

In this embodiment, the substrate 20 is made of light-transmissible material such as a glass plate or an acrylic plate. In another embodiment, the substrate 20 is made of opaque material or translucent material such as a glass plate with color or a ceramic plate. An example of the alarm device 25 includes but is not limited to a warning lamp, a buzzer, a wireless signal emitter, a network signal generator or a short message generator.

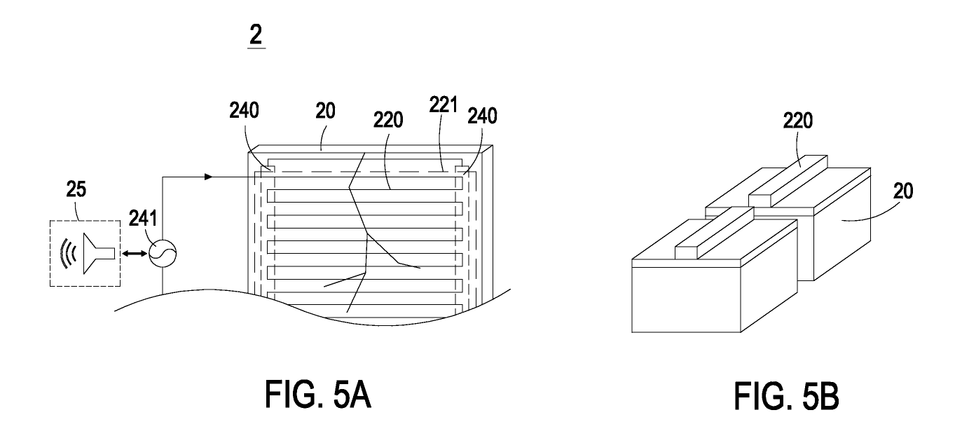

FIG. 4 is a schematic diagram illustrating the burglarproof security system of the present invention operated in a resistive detecting mode. As shown in FIG. 4, the switching device 240 of the sensing control unit 24 is selectively connected with the resistive sensing circuit 221, so that the burglarproof security system 2 is operated in a resistive detecting mode. In a case that the substrate 20 is suffered from impact or attacked by a throwing article to have a fracture or crack, one or more conducting wires 220 of the conducting wire layer 22 lying on the substrate 20 may be broken (see FIGS. 5A and 5B). In this situation, the resistive sensing circuit 221 is in the open-circuit status, and thus no current flows through the resistive sensing circuit 221 (i.e. the equivalent resistance of the resistive sensing circuit 221 is infinite). Once the detecting device 241 of the sensing control unit 24 judges that the resistive sensing circuit 221 is in the open-circuit status, a detecting signal indicative of the fracture or crack of the substrate 20 is generated and then transmitted to the alarm device 25. In response to the detecting signal, the alarm device 25 generates a warning signal to prompt the guard or the security service personnel. As a consequence, the burglarproof efficacy is enhanced and the false-alarm rate is reduced.

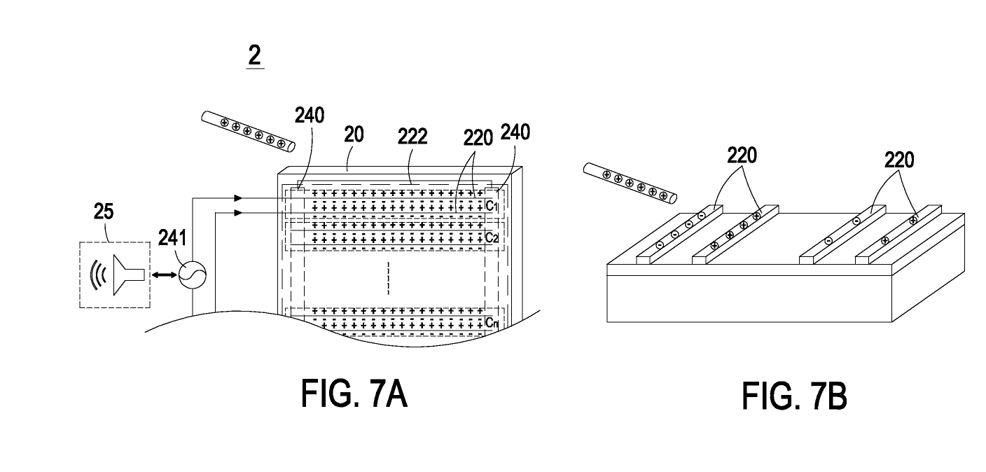

FIG. 6 is a schematic diagram illustrating the burglarproof security system of the present invention operated in a capacitive detecting mode. As shown in FIG. 6, the switching device 240 of the sensing control unit 24 is selectively connected with the capacitive sensing circuit 222, so that the burglarproof security system 2 is operated in a capacitive detecting mode. The plural conducting wires 220 of the conducting wire layer 22 lying on the substrate 20 collectively define plural capacitors C1, C2, . . . , Cn. The plural capacitors are connected with each other in series or in parallel. Each of the plural capacitors is connected to two conducting wires 220. In a case that the substrate 20 is touched by a foreign article or even the substrate 20 has a fracture or crack, the capacitance value of at least one capacitor of the capacitive sensing circuit 222 will be changed (see FIGS. 7A and 7B). Once the detecting device 241 of the sensing control unit 24 judges that the capacitance value of the capacitive sensing circuit 222 is changed, a detecting signal indicative of the fracture or crack of the substrate 20 or in response to a touching action of a foreign article is generated and then transmitted to the alarm device 25. In response to the detecting signal, the alarm device 25 generates a warning signal to prompt the guard or the security service personnel. As a consequence, the burglarproof efficacy is enhanced and the false-alarm rate is reduced.

The burglarproof security system 2 of the present invention may be operated in either a resistive detecting mode or a capacitive detecting mode. In the resistive detecting mode, the warning signal is issued when the substrate 20 has a fracture or crack and the resistive sensing circuit 221 is in the open-circuit status. Consequently, the detecting accuracy of the resistive detecting mode is increased and the false-alarm rate is largely reduced. As previously described, since the vibration sensor may only sense the local region of the glass plate, the conventional burglarproof security system has a dead sensing space. Whereas, since the conducting wires 220 may be distributed over the whole substrate 20, the burglarproof security system 2 of the present invention is suitable to sense a large area of the substrate 20 and the problems resulting from the dead sensing space will be eliminated. In the capacitive detecting mode, the warning signal is issued when the substrate 20 is touched by a foreign article or substrate 20 has a fracture or crack and thus the capacitance value of the capacitive sensing circuit 222 is changed. In other words, the detecting sensitivity of the burglarproof security system 2 in capacitive detecting mode will be increased.

From the above description, the burglarproof security system 2 may be selectively operated in an optimal detecting mode according to the practical requirements. In some embodiments, the burglarproof security system is only operated in the resistive detecting mode. In this situation, the switching device 240 of the sensing control unit 24 is omitted and the plural conducting wires 220 are directly defined as the resistive sensing circuit 221. In some embodiments, the burglarproof security system 2 is only operated in the capacitive detecting mode. In this situation, the switching device 240 of the sensing control unit 24 is omitted and the plural conducting wires 220 are directly defined as the capacitive sensing circuit 222. The operating principles and the configurations of the burglarproof security system are similar to those illustrated in FIGS. 4 and 6, and are not redundantly described herein.

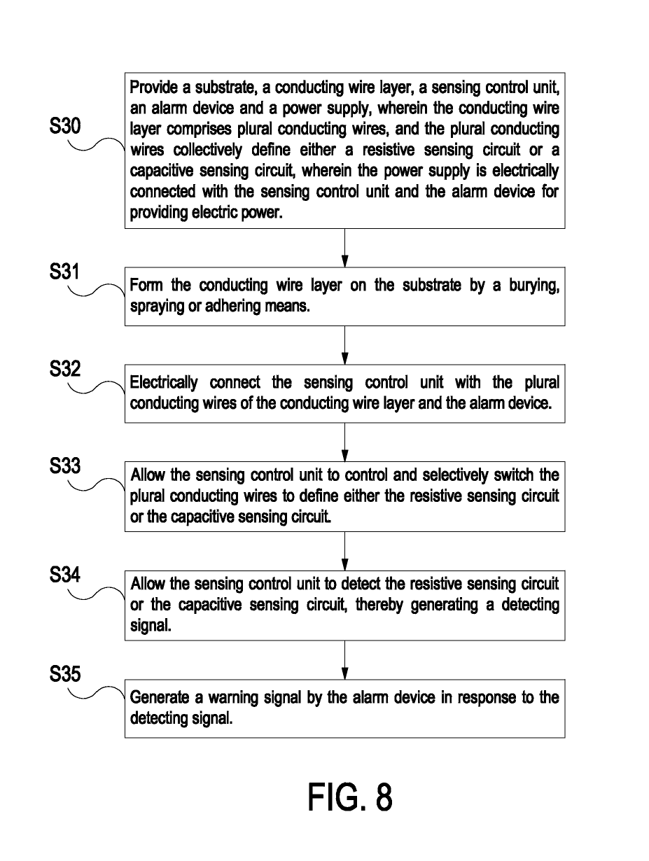

FIG. 8 is a flowchart illustrating a method of installing a burglarproof security system according to an embodiment of the present invention. First of all, in the step S30, a substrate 20, a conducting wire layer 22, a sensing control unit 24, an alarm device 25 and a power supply 26 are provided, wherein the conducting wire layer 22 comprises plural conducting wires 220, and the plural conducting wires 220 collectively define either a resistive sensing circuit 221 or a capacitive sensing circuit 222. In addition, the power supply 26 is electrically connected with the sensing control unit 24 and the alarm device 25 for providing electric power. Then, in the step S31, the conducting wire layer 22 is formed on the substrate 20 by a burying, spraying or adhering means. Then, in the step S32, the sensing control unit 24 is electrically connected with the plural conducting wires 220 of the conducting wire layer 22 and the alarm device 25.

Then, in the step S33, the sensing control unit 24 controls and selectively switches the plural conducting wires 220 to define either the resistive sensing circuit 221 or the capacitive sensing circuit 222. Then, in the step S34, the resistive sensing circuit 221 or the capacitive sensing circuit 222 is detected by the sensing control unit 24, thereby generating a detecting signal. For example, in a case that the substrate 20 has a fracture or crack and the resistive sensing circuit 221 is in the open-circuit status, a detecting signal indicative of the fracture or crack of the substrate 20 is generated. Whereas, in a case that the substrate 20 is touched by a foreign article or has a fracture or crack, a detecting signal indicative of the fracture or crack of the substrate 20 or in response to a touching action of a foreign article is generated. In the step S35, in response to the detecting signal, the alarm device 25 generates a warning signal to prompt the guard or the security service personnel. As a consequence, the burglarproof efficacy is enhanced and the false-alarm rate is reduced.

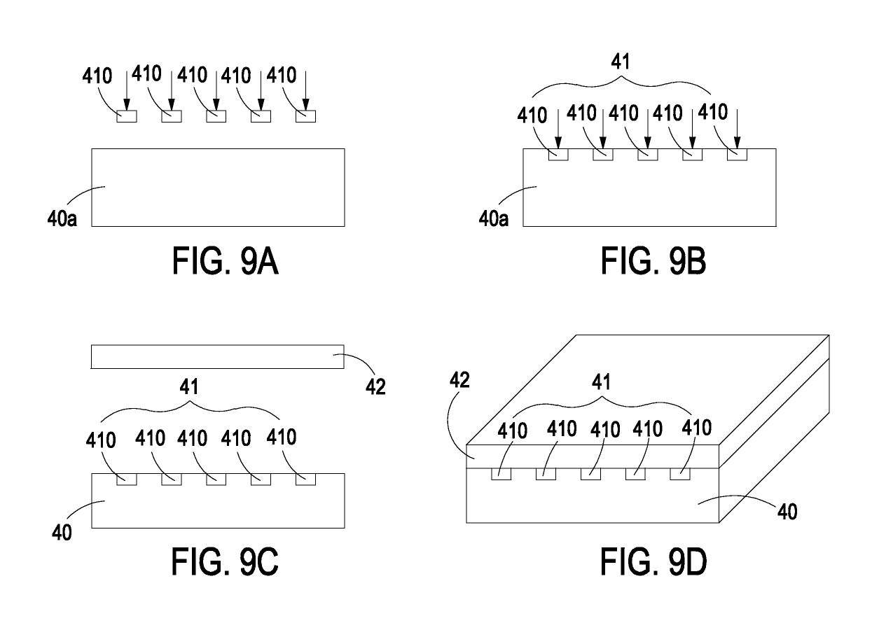

FIGS. 9A˜9D schematically illustrate the steps of forming a conducting wire layer on a substrate by a burying means. As shown in FIG. 9A, a substrate material 40a is firstly provided. Then, by a specified burying machine (not shown), plural conducting wires 410 are buried in the surface of the substrate material 40a. The plural conducting wires 410 are parallel with each other to form a conducting wire layer 41 (see FIG. 9B). After the substrate material 40a is solidified, the substrate material 40a is transformed into a substrate 40. Meanwhile, the substrate 40 with a buried conducting wire layer 41 is produced.

Optionally, for protecting the conducting wire layer 41, a protective layer 42 is formed on the substrate 40 and the conducting wire layer 41 (see FIG. 9C). An example of the protective layer 42 includes but is not limited to a translucent film, an anti-UV film or a light-shading film. After the protective layer 42 is formed on the substrate 40, the protective layer 42 may provide translucent, anti-UV or light-shading efficacy. The protective layer 42 is made of a material having desired light-transmissible, thermal-resistant and size-stable properties. The protective layer 42 is made of a transparent plastic material. For example, the protective layer 42 is a PC (polycarbonate) film, a PET (polyethylene terephthalate) film or PEN (polyethylene naphthalate) film. As a consequence, the protective layer 42 may protect the conducting wire layer 41 while maintaining good light-transmissible, thermal-resistant and size-stable properties.

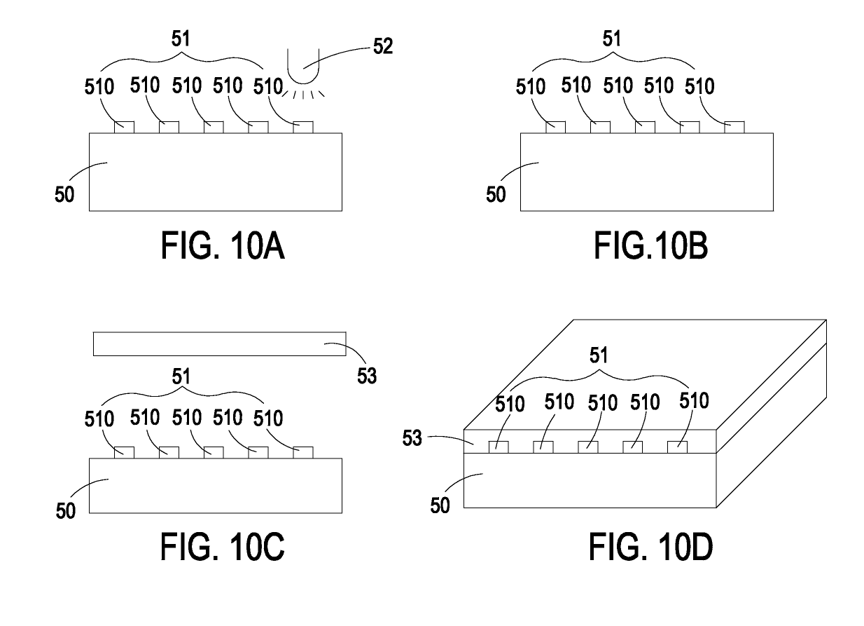

FIGS. 10A˜10D schematically illustrate the steps of forming a conducting wire layer on a substrate by a spraying means. As shown in FIG. 10A, a substrate 50 is firstly provided. Then, by a spray pen 52 of a spraying device (not shown), plural conducting wires 510 are printed or painted on a surface of the substrate 50. It is preferred that the plural conducting wires 510 are linearly printed or painted at regular intervals. As a consequence, the plural conducting wires 510 are parallel with each other to form a conducting wire layer 51 (see FIG. 10B). Optionally, for protecting the conducting wire layer 51, a protective layer 52 is formed on the substrate 50 and the conducting wire layer 51 (see FIGS. 10C and 10D). As a consequence, the protective layer 52 may protect the conducting wire layer 51 while maintaining good light-transmissible, thermal-resistant and size-stable properties. The protective layer 52 is made of a material similar to that illustrated in FIG. 9, and is not redundantly described herein.

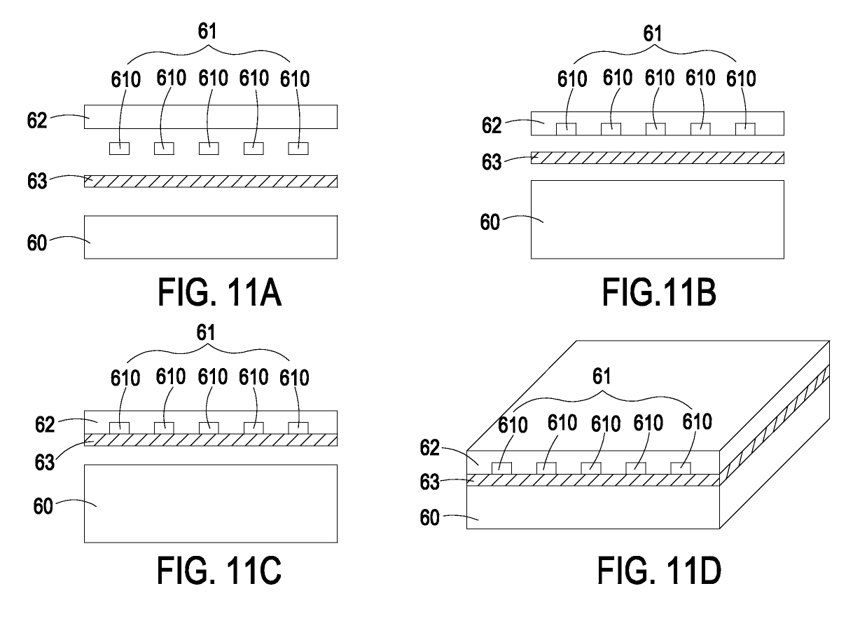

FIGS. 11A˜11D schematically illustrate the steps of forming a conducting wire layer on a substrate by an adhering means. As shown in FIG. 11A, a substrate 60, a protective layer 62, plural conducting wires 610 and an adhesive layer 63 are provided. The plural conducting wires 610 are parallel with each other to form a conducting wire layer 61. The conducting wire layer 61 is formed on the protective layer 62 by a silkscreen process for example (see FIG. 11B). According to the current silkscreen process, very thin plural conducting wires 610 may be easily formed on the protective layer 62. Alternatively, the conducting wire layer 61 may be produced by an electroplating process, a chemical vapor deposition (CVD) process or a chemical sputtering process. The operating conditions should be selected according to undue experiments.

Then, as shown in FIGS. 11C and 11D, the protective layer 62 containing the conducting wire layer 61 is adhered on the substrate 60 via the adhesive layer 63. An example of the protective layer 62 includes but is not limited to a translucent film, an anti-UV film or a light-shading film. After the protective layer 62 is adhered on the substrate 60, the protective layer 62 may provide translucent, anti-UV or light-shading efficacy. The protective layer 62 is made of a material similar to that illustrated in FIG. 9, and is not redundantly described herein. For complying with the light-transmissible, thermal-resistant and size-stable properties of the protective layer 62, the conducting wire layer 61 is preferably made of transparent conducting material such as indium zinc oxide (IZO) or indium thin oxide (ITO).

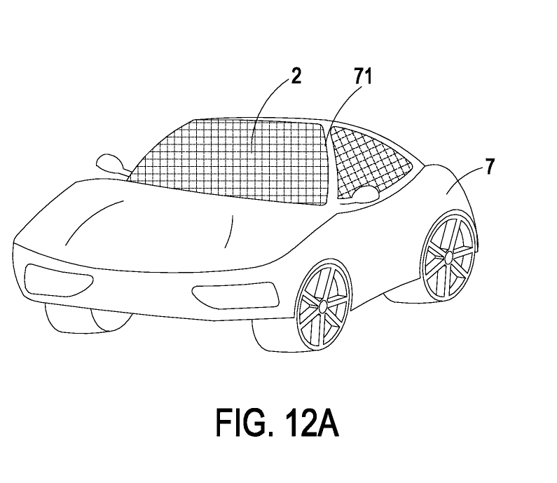

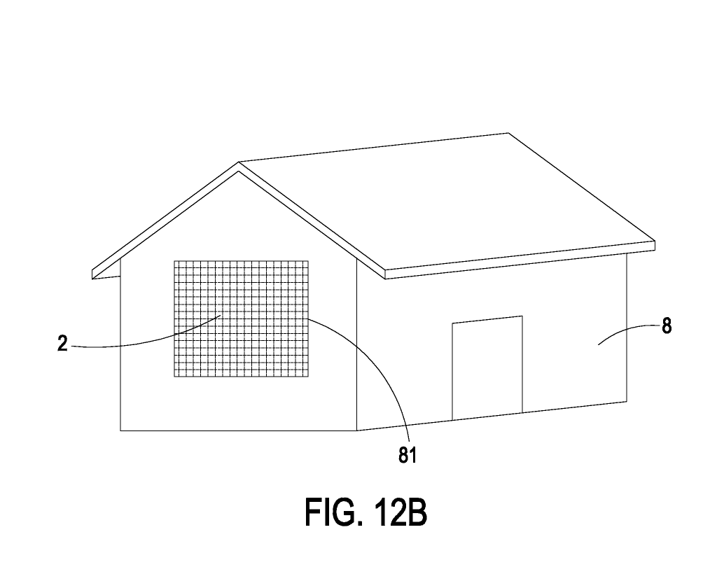

FIGS. 12A and 12B are schematic diagrams illustrating two application examples of a burglarproof security system according to an embodiment of the present invention. As shown in FIG. 12A, the burglarproof security system 2 is installed on a windshield 71 of a vehicle 7. As shown in FIG. 12B, the burglarproof security system 2 is installed on a window 81 of a house 8. The conducting wire layer is directly formed on the substrate (e.g. the windshield 71 or the window 81) by a burying or spraying means for example, and then a protective layer is placed on the conducting wire layer to protect the conducting wire layer and shelter heat and strong light. In this situation, the burglarproof security system may be simultaneously installed during the process of producing the substrate (e.g. the windshield 71 or the window 81). Alternatively, the protective layer, the conducting wire layer and the adhesive layer are collectively formed as a heat-insulation sticker to replace the conventional heat-insulation paper. The heat-insulation sticker will provide heat-insulating and light-shielding efficacy as well as the burglarproof efficacy. In other words, the method of installing the burglarproof security system is diversified.

From the above description, the burglarproof security system of the present invention is installed on a substrate (e.g. a glass plate, an acrylic plate or ceramic plate) in order to achieve a burglarproof security purpose and meet a cost-effective requirement. Moreover, the burglarproof security system of the present invention may be operated in different detecting modes according to the practical requirements, so that the detecting sensitivity and accuracy are both taken into consideration. The conducting wire layer is formed on a substrate by a burying, spraying or adhering means. The burglarproof security system is capable of detecting whether the substrate has a fracture or crack or is touched by a foreign article. For example, the burglarproof security system of the present invention may be operated in resistive detecting mode or a capacitive detecting mode. In the resistive detecting mode, the detecting accuracy is very high and the false-alarm rate is largely reduced. In the capacitive detecting mode, detecting sensitivity of the burglarproof security system is increased. As a consequence, the burglarproof security system may be selectively operated in an optimal detecting mode according to the practical requirements.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A burglarproof security system, comprising:
a substrate;
a conducting wire layer disposed on said substrate, and comprising plural conducting wires, wherein said plural conducting wires collectively define either a resistive sensing circuit or a capacitive sensing circuit;
a sensing control unit electrically connected with said plural conducting wires of said conducting wire layer for controlling and selectively switching said plural conducting wires to define either said resistive sensing circuit or said capacitive sensing circuit, and detecting said resistive sensing circuit or said capacitive sensing circuit, thereby generating a detecting signal;
an alarm device in communication with said sensing control unit for receiving said detecting signal from said sensing control unit, thereby generating a warning signal; and
a power supply electrically connected with said sensing control unit and said alarm device for providing electric power.

2. The burglarproof security system according to claim 1 wherein said conducting wire layer is formed on said substrate by a burying, spraying or adhering means.

3. The burglarproof security system according to claim 1 wherein said burglarproof security system further comprises a protective layer, which is disposed on said substrate and said conducting wire layer.

4. The burglarproof security system according to claim 3 wherein said burglarproof security system further comprises an adhesive layer, wherein said protective layer, said conducting wire layer and said adhesive layer are collectively formed as a heat-insulation sticker.

5. The burglarproof security system according to claim 1 wherein said sensing control unit comprises:
a switching device electrically connected to said plural conducting wires of said conducting wire layer for controlling and selectively switching said plural conducting wires to define either said resistive sensing circuit or said capacitive sensing circuit; and
a detecting device electrically connected with said resistive sensing circuit or said capacitive sensing circuit for detecting said resistive sensing circuit or said capacitive sensing circuit, thereby generating said detecting signal.

6. The burglarproof security system according to claim 5 wherein if said substrate has a fracture or crack, said detecting device judges that said resistive sensing circuit is in an open-circuit status, so that said a detecting signal indicative of the fracture or crack of said substrate is generated by said detecting device.

7. The burglarproof security system according to claim 5 wherein if said substrate has a fracture or crack or is touched by a foreign article, a capacitance change of said capacitive sensing circuit is changed and a corresponding detecting signal is generated by said detecting device.

8. The burglarproof security system according to claim 1 wherein said capacitive sensing circuit comprises plural capacitors, wherein each of said plural capacitors is connected to at least two conducting wires.

9. The burglarproof security system according to claim 1 wherein said substrate is made of a light-transmissible material, a translucent material or an opaque material.

10. The burglarproof security system according to claim 1 wherein said substrate is a glass plate, an acrylic plate or a ceramic plate.

11. The burglarproof security system according to claim 1 wherein said conducting wire layer is made of indium zinc oxide or indium thin oxide.

12. The burglarproof security system according to claim 1 wherein said alarm device is a warning lamp, a buzzer, a wireless signal emitter, a network signal generator, a short message generator or a combination thereof.

13. A burglarproof security system, comprising:
a substrate;
a conducting wire layer disposed on said substrate, and comprising plural conducting wires, wherein said plural conducting wires collectively define either a resistive sensing circuit or a capacitive sensing circuit;
a sensing control unit comprising a detecting device, wherein said detecting device is electrically connected with either said resistive sensing circuit or said capacitive sensing circuit for detecting said resistive sensing circuit or said capacitive sensing circuit, thereby generating a detecting signal; and
an alarm device in communication with said sensing control unit for receiving said detecting signal from said sensing control unit, thereby generating a warning signal.

14. A method of installing a burglarproof security system, said method comprising steps of:
(a) providing a substrate, a conducting wire layer, a sensing control unit, an alarm device and a power supply, wherein said conducting wire layer comprises plural conducting wires, and said plural conducting wires collectively define either a resistive sensing circuit or a capacitive sensing circuit, wherein said power supply is electrically connected with said sensing control unit and said alarm device for providing electric power;
(b) forming said conducting wire layer on said substrate; and
(c) electrically connecting said sensing control unit with said plural conducting wires of said conducting wire layer and said alarm device.

15. The method according to claim 14 wherein after said step (c), said method further comprises steps:
(d) allowing said sensing control unit to control and selectively switch said plural conducting wires to define either said resistive sensing circuit or said capacitive sensing circuit;
(e) allowing said sensing control unit to detect said resistive sensing circuit or said capacitive sensing circuit, thereby generating a detecting signal; and
(f) generating a warning signal by said alarm device in response to said detecting signal.

16. The method according to claim 15 wherein said sensing control unit comprises:
a switching device electrically connected to said plural conducting wires of said conducting wire layer for controlling and selectively switching said plural conducting wires to define either said resistive sensing circuit or said capacitive sensing circuit; and
a detecting device electrically connected with said resistive sensing circuit or said capacitive sensing circuit for detecting said resistive sensing circuit or said capacitive sensing circuit, thereby generating said detecting signal.

17. The method according to claim 14 wherein said conducting wire layer is formed on said substrate by a burying means, and said step (b) further comprising sub-steps of:
(b11) providing a substrate, and burying said plural conducting wires on a surface of said substrate to form said conducting wire layer;
(b12) solidifying said substrate, so that said substrate is transformed into said substrate; and
(b13) forming a protective layer on said substrate and said conducting wire layer to protect said conducting wire layer.

18. The method according to claim 14 wherein said conducting wire layer is formed on said substrate by a spraying means, and said step (b) further comprising sub-steps of:
(b21) printing or painting plural parallel conducting wires on a surface of said substrate by a spray pen of a spraying device, thereby forming said conducting wire layer; and
(b22) forming a protective layer on said substrate and said conducting wire layer to protect said conducting wire layer.

19. The method according to claim 14 wherein said conducting wire layer is formed on said substrate by an adhering means, and said step (b) further comprising sub-steps of:
(b31) providing a protective layer and an adhesive layer, and forming said plural conducting wires on said protective layer to form said conducting wire layer; and
(b32) adhering said protective layer containing said conducting wire layer on said substrate via said adhesive layer.

20. The method according to claim 19 wherein said conducting wire layer is formed on said protective layer by a silkscreen process, an electroplating process, a chemical vapor deposition process or a chemical sputtering process.
